(19) United States
(12) Patent Application Publication
(10) Pub. No.: US 2021/0224761 A1
(43) Pub. Date: Jul. 22, 2021

(54) SERVER, INFORMATION PROCESSING SYSTEM, CONTROL APPARATUS, MOBILE STORE, TERMINAL APPARATUS, MEDIUM, AND OPERATION METHOD OF INFORMATION PROCESSING SYSTEM

(71) Applicant: TOYOTA JIDOSHA KABUSHIKI KAISHA, Toyota-shi (JP)

(72) Inventors: Ryosuke KOBAYASHI, Nagakute-shi (JP); Ayana TAKESHITA, Kasugai-shi (JP); Naoki YAMAMURO, Nagoya-shi (JP); Takuya MAEKAWA, Nagoya-shi (JP); Yugo SAKURAI, Setagaya-ku (JP)

(73) Assignee: TOYOTA JIDOSHA KABUSHIKI KAISHA, Toyota-shi (JP)

(21) Appl. No.: 17/140,255

(22) Filed: Jan. 4, 2021

(30) Foreign Application Priority Data
Jan. 21, 2020 (JP) 2020-007878

(51) Int. Cl. G06Q 20/08; H04L 29/08; G06Q 10/04; G06Q 30/02; G07C 5/00; G01C 21/34

(52) U.S. Cl. CPC G06Q 20/085; H04L 67/12; G06Q 10/047; G06Q 20/02; G07C 5/008; G01C 21/3453; G01C 21/343; G06Q 30/0284

(57) ABSTRACT

A server includes a communication interface and a controller that transmits and receives information to and from other apparatuses via the communication interface. The controller receives information on a cruising range from each mobile store among a plurality of mobile stores selling different types of products and transmits an instruction to the mobile stores to circulate as a group along a circulation route travelable by a first mobile store having the shortest cruising range.

### CROSS-REFERENCE TO RELATED APPLICATION

This application claims priority to and the benefit of Japanese Patent Application No. 2020-7878, the entire contents of which are incorporated herein by reference.

### TECHNICAL FIELD

The present disclosure relates to a server, an information processing system, a control apparatus, a mobile store, a terminal apparatus, a medium, and an operation method of an information processing system.

### BACKGROUND

The sale of products by a mobile store in which a vehicle is equipped with a store facility is known. Merchants may come into contact with consumers in various ways to sell products, such as establishing a presence by sending a mobile store to an event venue or the like or selling products through a mobile store that circulates around residential areas or the like. In the case of sales by mobile stores, the choice of store locations or circulation routes could affect the sales volume. Patent literature (PTL) 1 discloses a technique for supporting product sales by a mobile store by, for example, collecting demand information of consumers in the region to create a circulation schedule.

### CITATION LIST

### Patent Literature

PTL 1: JP 2015-069594 A

### SUMMARY

Techniques that support product sales by mobile stores have room for improvement in terms of consumer convenience and efficiency for merchants.

It would therefore be helpful to provide a server and the like that can improve both consumer convenience and efficiency for the merchant in the context of product sales by a mobile store.

A server according to the present disclosure includes a communication interface and a controller configured to transmit and receive information to and from other apparatuses via the communication interface. The controller is configured to receive information on a cruising range from each mobile store among a plurality of mobile stores selling different types of products and to transmit an instruction to the plurality of mobile stores to circulate as a group along a circulation route travelable by a first mobile store having a shortest cruising range.

A control apparatus according to the present disclosure is to be mounted in a mobile store and configured to transmit and receive information to and from a server and to control the mobile store. The control apparatus is configured to transmit information on a cruising range of the mobile store to the server. Based on the information on the cruising range of the mobile store and information, transmitted from another mobile store configured to sell a different type of products from products sold by the mobile store, on the cruising range of the other mobile store, an instruction to circulate as a group along a circulation route travelable by the mobile store having a shortest cruising range is transmitted from the server to the mobile store and the other mobile store. The control apparatus is configured to receive the instruction and control the mobile store to circulate along the circulation route.

An operation method according to the present disclosure is an operation method of an information processing system including a server and a plurality of mobile stores configured to communicate with the server. The operation method includes selling, by each mobile store, different types of products and transmitting, by each mobile store, a cruising range of the mobile store to the server. The operation method also includes transmitting, by the server, an instruction to each mobile store to circulate as a group along a circulation route travelable by a first mobile store having a shortest cruising range.

The server and the like according to the present disclosure can improve both consumer convenience and efficiency for the merchant in the context of product sales by a mobile store.

### BRIEF DESCRIPTION OF THE DRAWINGS

In the accompanying drawings:

FIG. 1 illustrates an example configuration of an information processing system;

FIG. 2 illustrates an example configuration of a server;

FIG. 3 illustrates an example configuration of a terminal apparatus;

FIG. 4 illustrates an example configuration of a mobile store;

FIG. 5 is a sequence diagram illustrating an operation example of the information processing system; and

FIG. 6 is a sequence diagram illustrating an operation example of the information processing system.

### DETAILED DESCRIPTION

Embodiments are described below.

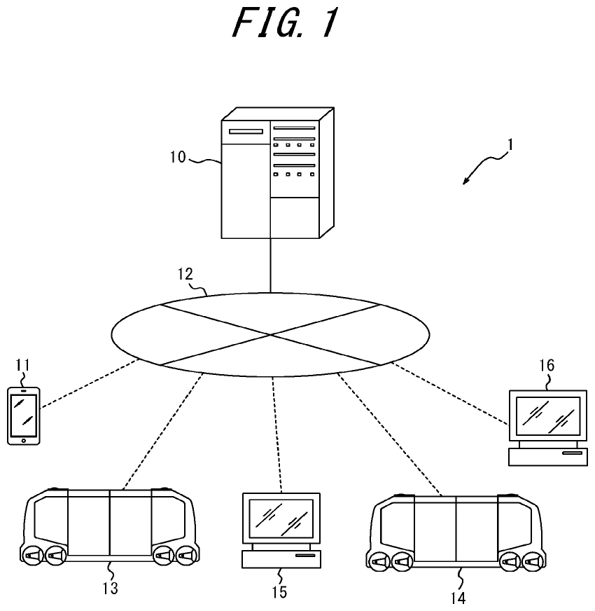

FIG. 1 illustrates an example configuration of an information processing system in an embodiment. The information processing system 1 includes, for example, a server 10, terminal apparatuses 11, 15, 16, and mobile stores 13, 14 communicatively connected to each other via a network 12. The server 10 is a computer. The terminal apparatuses 11, 15, 16 are, for example, information terminal apparatuses such as personal computers, tablet terminal apparatuses, or smartphones. The mobile stores 13, 14 are multi-purpose vehicles equipped with store facilities and with control and communication functions. The network 12 is, for example, the Internet, but may include an ad hoc network, a LAN, a metropolitan area network (MAN), or other networks, or any combination thereof. The number of each component included in the information processing system 1 may be greater than the case illustrated here.

The information processing system 1 supports circuit sales by a plurality of mobile stores 13, 14. The mobile stores 13, 14 are operated by different merchants and sell different types of products, such as food and drink, clothing and accessories, or books and writing supplies. The server 10 provides, for example, a portal site for dispatching mobile stores 13, 14 in response to consumer demand. The consumer accesses the portal site of the server 10 over the network 12 via a terminal apparatus (consumer terminal apparatus) 11. The merchants who operate the mobile stores 13, 14 (merchant A and merchant B, respectively) access the portal site of the server 10 through the network 12 by means of terminal apparatuses (merchant terminal apparatuses) 15, 16, respectively. The server 10 receives requests from consumers at the portal site, collects information on the types of products in the mobile stores 13, 14 of merchants A and B, and combines mobile stores 13, 14 that yield a combination of the products requested by the consumer. The server 10 instructs the mobile stores 13, 14 to sell the respective products by circulating as a group, for example as a convoy over a common circulation route.

During circuit sales, the mobile stores 13, 14 have a finite cruising range corresponding to the remaining amount of the energy source used in the respective drive mechanisms. if the cruising range differs between the mobile stores 13, 14, the mobile stores 13, 14 cannot circulate as a group unless the circulation route can be traversed by the mobile store with the shorter cruising range. The server 10 therefore collects the cruising ranges of the mobile stores 13, 14 and determines a common circulation route with a distance that can be traversed by the mobile store having the shortest cruising range. The common circulation route is, for example, a route to circulate through any area, such as a residential district, a business district, or a busy district. The mobile stores 13, 14 then sell products by circulating through the common circulation route in a group based on an instruction from the server 10.

The information processing system 1 operating as described above can optimize the circuit of the plurality of mobile stores 13, 14 while providing a combination of different types of products more suited to the needs of the consumer.

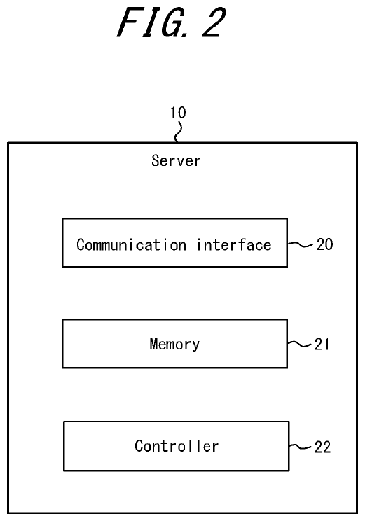

FIG. 2 illustrates an example configuration of the server 10. The server 10 includes a communication interface 20, a memory 21, and a controller 22. The server 10 may execute operations in the present embodiment by communicating and cooperating with another server having the same configuration.

The communication interface 20 includes a communication module compliant with one or more wired or wireless LAN standards for connecting to the network 12. In the present embodiment, the server 10 is connected to the network 12 via the communication interface 20 and communicates information with other apparatuses through the network 12.

The memory 21 includes, for example, a semiconductor memory, a magnetic memory, or an optical memory. The memory 21 functions as, for example, a main storage device, an auxiliary storage device, or a cache memory. The memory 21 stores any information, control and processing programs, and the like used in the operation of the server 10. For example, the memory 21 stores information required to determine the common circulation route, such as map information of the region where the mobile stores 13, 14 circulate and passing points through which the mobile stores 13, 14 are to pass.

The controller 22 may, for example, include one or more general purpose processors, such as a central processing unit (CPU), or one or more dedicated processors specialized for a particular process. Alternatively, the controller 22 may include dedicated circuitry such as one or more field-programmable gate arrays (FPGAs) or application specific integrated circuits (ASICs). The controller 22 operates according to a control and processing program, or operates according to an operation procedure implemented as circuitry, to comprehensively control the operation of the server 10. The controller 22 transmits and receives various information to and from the consumer terminal apparatus 11, the mobile stores 13, 14, and the merchant terminal apparatuses 15, 16 via the communication interface 20 and executes the operations according to the present embodiment.

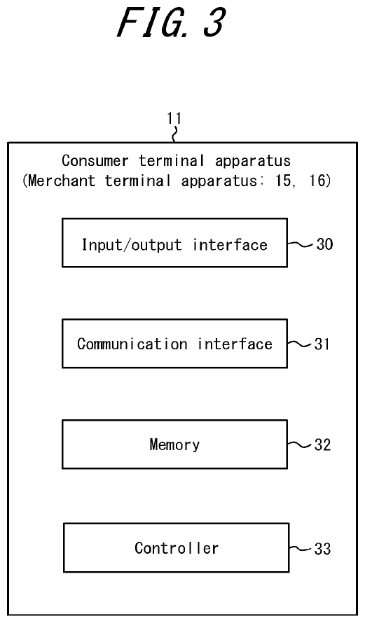

FIG. 3 illustrates an example configuration of the consumer terminal apparatus 11. The example configuration of the consumer terminal apparatus 11 illustrated here also applies to the merchant terminal apparatuses 15, 16. The consumer terminal apparatus 11 is an information processing terminal apparatus, such as a personal computer, a tablet terminal apparatus, or a smartphone. The consumer terminal apparatus 11 includes an input/output interface 30, a communication interface 31, a memory 32, and a controller 33.

The input/output interface 30 includes an input interface that detects user input and transmits the input information to the controller 33. The input interface may be any type of input interface, such as a physical key, a capacitance key, a touch screen integrally provided with a panel display, various pointing devices, a microphone for receiving audio input, or a camera for capturing images or image codes. The input/output interface 30 also includes an output interface that outputs information, generated by the controller 33 or received from another apparatus, to the user. The output interface may be any type of output interface, such as an external or built-in display for outputting information as an image or video, a speaker for outputting information as audio, or an interface for connecting with an external output device.

The communication interface 31 includes a communication module compliant with a wired or wireless LAN standard, a module compliant with a mobile object communication standard such as 4^{th} generation (4G) or 5^{th} Generation (5G), or the like. The consumer terminal apparatus 11 is connected by the communication interface 31 to the network 12 via a nearby router or a base station for mobile object communication and communicates information with other apparatuses over the network 12.

The memory 32 includes, for example, a semiconductor memory, a magnetic memory, or an optical memory. The memory 32 functions as, for example, a main storage device, an auxiliary storage device, or a cache memory. The memory 32 stores any information, control and processing programs, and the like used in the operation of the consumer terminal apparatus 11.

The controller 33 may, for example, include one or more general purpose processors such as CPUs or micro processing unit (MPUs), or one or more dedicated processors specialized for a particular process. Alternatively, the controller 33 may include dedicated circuitry, such as one or more FPGAs or ASICs. The controller 33 operates according to a control and processing program, or operates according to an operation procedure implemented as circuitry, to comprehensively control the operation of the consumer terminal apparatus 11. The controller 33 transmits and receives various types of information to and from the server 10 and the like via the communication interface 31 and executes the operations according to the present embodiment.

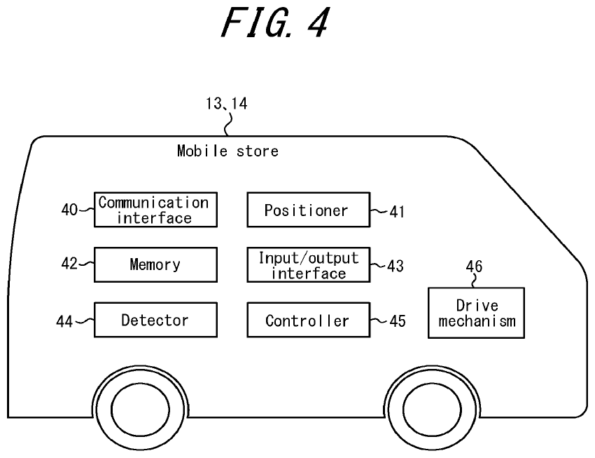

FIG. 4 illustrates an example configuration of the mobile store 13. The example configuration of the mobile store 13 illustrated here also applies to the mobile store 14. The mobile store 13 is a multi-purpose vehicle in which equipment corresponding to the application can be loaded in the vehicle interior space. The mobile store 13 can be driven manually or driven automatically with or without an operator. In the present embodiment, the mobile store 13 is configured to have a store facility mounted therein for selling products. The store facility is configured to be open to the outside of the vehicle so that consumers outside the vehicle can view and handle products in the store facility. Alternatively, the store facility may be configured so that consumers can enter the interior to view and handle products. Such a store facility may be managed and operated by a salesperson onboard the mobile store 13 or may be left unattended. The mobile store 13 sells products to consumers through the store facility by parking at a parking point while circulating along the circulation route or by parking at an arbitrary point in response to consumer demand.

The mobile store 13 has a drive mechanism 46 for moving the mobile store 13. The drive mechanism 46 includes, for example, one or more of an internal combustion engine that runs on fossil fuel as an energy source, an electric motor that runs on the power of a storage battery as an energy source, and an electric motor that runs on the power of a fuel cell that uses various chemical fuels as an energy source. The drive mechanism 46 also includes equipment that stores the energy sources. The mobile store 13 has a cruising range corresponding to the remaining amount of the energy source of the drive mechanism, i.e. the amount of fossil or chemical fuel in the tank, the remaining charge of the storage battery, or the like. The cruising range in the present embodiment refers to the distance that the mobile store 13 can travel using the remaining amount of the energy source at a certain point in time, without replenishing the energy source.

The mobile store 13 further includes a communication interface 40, a positioner 41, a memory 42, an input/output interface 43, a detector 44, and a controller 45. The components are communicably connected to each other in a wired or wireless manner via an on-board network, such as a controller area network (CAN), or a dedicated line, for example. A portion or all of the communication interface 40, positioner 41, memory 42, input/output interface 43, detector 44, and controller 45 may be provided directly in the mobile store 13 or may be provided in a control apparatus that is detachable from the mobile store 13, such as a car navigation apparatus. The mobile store 13 may be driven by a driver, or driving may be automated at any level. The level of automation is, for example, one of level 1 to level 5 in the level classification of the Society of Automotive Engineers (SAE).

The communication interface 40 includes a communication module compliant with a wired or wireless LAN standard, a module compliant with a mobile object communication standard such as 4G or 5G, or the like. The mobile store 13 is connected to the network 12 by the communication interface 40 via a base station for mobile object communication and communicates information with other devices over the network 12.

The positioner 41 measures the position of the mobile store 13 and generates position information. The position information is information including coordinates, such as two-dimensional coordinates or three-dimensional coordinates, that identify a position on the map. The position information is not limited to coordinates and may include the speed, circulation route, or travel distance, the amount or rate of change thereof, or the like. The positioner 41 includes a receiver corresponding to a satellite positioning system. The satellite positioning system to which the receiver corresponds may, for example, be a global positioning system (GPS). Alternatively, the positioner 41 may include an accelerometer, a gyroscopic sensor, or the like. A car navigation apparatus, for example, may function as the positioner 41.

The memory 42 includes, for example, a semiconductor memory, a magnetic memory, or an optical memory. The memory 42 functions as, for example, a main storage device, an auxiliary storage device, or a cache memory. The memory 42 stores any information, control and processing programs, and the like used for controlling the operation of the mobile store 13.

The input/output interface 43 includes an input interface that detects user input and transmits the input information to the controller 45. The input interface may be any type of input interface, such as a physical key, a capacitance key, a touch screen integrally provided with a panel display, various pointing devices, a microphone for receiving audio input, a camera for capturing images or image codes, an IC card reader, or the like. The input/output interface 43 also includes an output interface that outputs information, generated by the controller 45 or received from the server 10, to the user. The output interface may be any type of output interface, such as a display for outputting information as an image or video, a speaker for outputting information as audio, or an interface for connecting with an external output device.

The detector 44 includes sensors for detecting the remaining amount of the energy source of the drive mechanism 46. The detector 44 may include sensors that detect various vehicle conditions such as vehicle speed, acceleration, steering angle, and inclination of the mobile store 13. The sensors of the detector 44 transmit the detected information to the controller 45.

The controller 45 may include one or more general purpose processors, such as CPUs or MPUs, or one or more dedicated processors specialized for a particular process. Alternatively, the controller 45 may include dedicated circuitry, such as one or more FPGAs or ASICs. The controller 45 operates according to a control and processing program, or operates according to an operation procedure implemented as circuitry, to comprehensively control the operation of the mobile store 13, including the communication interface 40, positioner 41, memory 42, input/output interface 43, detector 44, and drive mechanism 46. When the mobile store 13 is driven automatically, the controller 45 transmits the information required for the operation of the mobile store 13 to a control apparatus that controls the automatic driving of the drive mechanism 46. The controller 45 transmits and receives various information to and from the server 10 via the communication interface 40 and executes the operations according to the present embodiment.

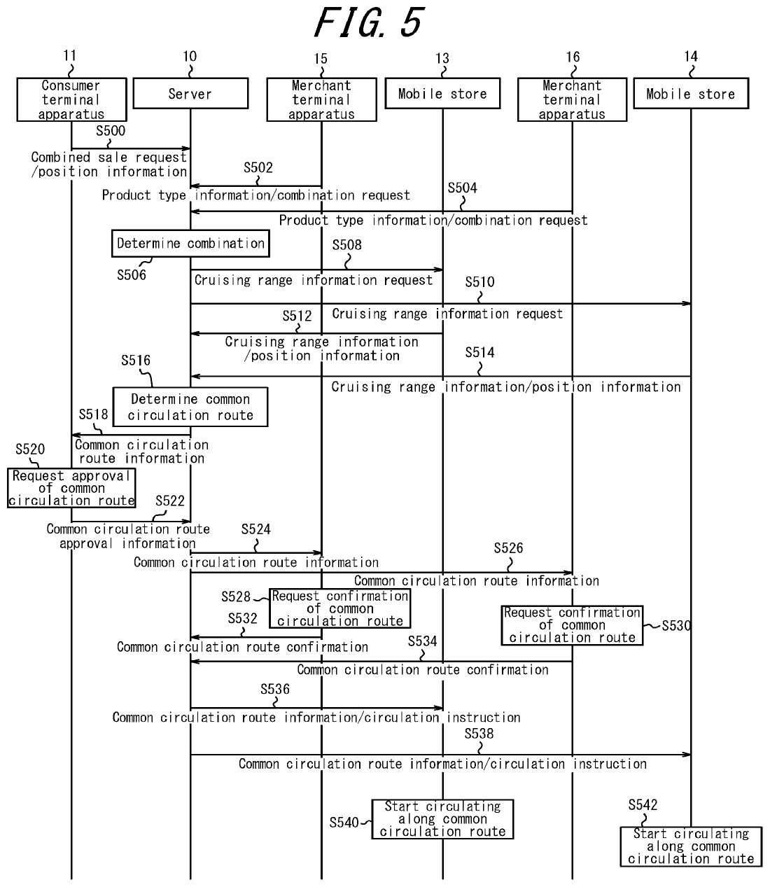

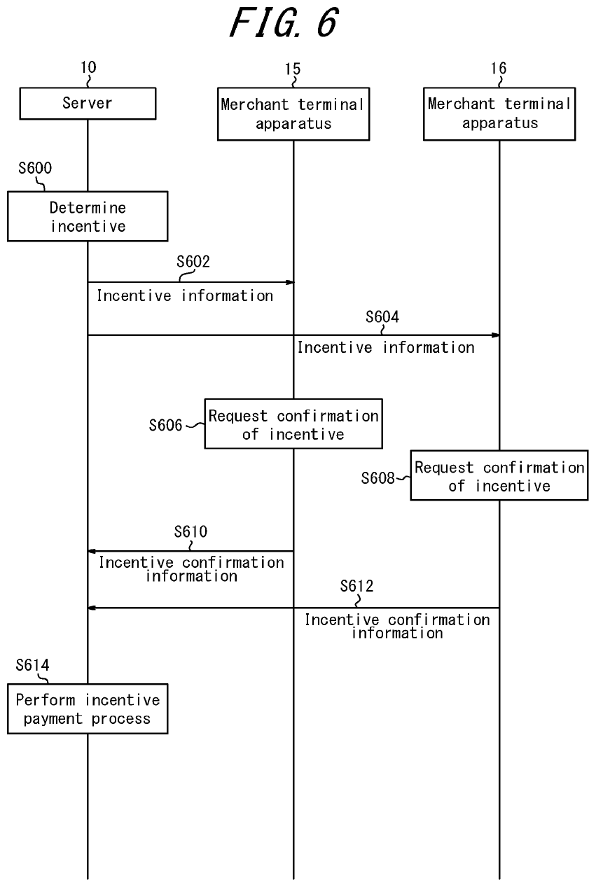

FIGS. 5 to 6 are sequence diagrams illustrating an operation example of the information processing system 1. FIGS. 5 and 6 illustrate operational procedures for cooperative operation by the server 10, the mobile stores 13, 14, the consumer terminal apparatus 11, and the merchant terminal apparatuses 15, 16.

FIG. 5 illustrates an operation procedure of the information processing system 1 when the mobile stores 13, 14 perform circuit sales as a group.

In step S500, the controller 33 of the consumer terminal apparatus 11 transmits, to the server 10 via the communication interface 31, position information and a request for the combined sale of different types of products in response to input from the consumer. The controller 22 of the server 10 then receives the request for combined sale and the position information via the communication interface 20. For example, the consumer uses the consumer terminal apparatus 11 to access the portal site provided by the server 10, selects a combination of desired types of products from among preset alternatives or freely inputs the combination of desired types of products, and furthermore inputs position information indicating the location of the consumer. The location of the consumer may be stored in advance in the memory 21 of the server 10 as member information in association with a member ID, and the controller 22 of the server 10 may read the location of the consumer corresponding to the member ID after the consumer transmits the member ID from the consumer terminal apparatus 11.

In step S502, the controller 33 of the merchant terminal apparatus 15 transmits information on the types of products sold in the mobile store 13 and a request for combination with another mobile store that sells different types of products to the server 10 via the communication interface 31 in response to input from the merchant A, who operates the mobile store 13. The controller 22 of the server 10 then receives the information on the types of products and the request for combination via the communication interface 20. For example, the merchant A accesses the portal site provided by the server 10 using the merchant terminal apparatus 15, inputs the types of products of the mobile store 13 operated by the merchant A, and requests combination with another store.

In step S504, as in step S502, the controller 33 of the merchant terminal apparatus 16 transmits information on the types of products sold in the mobile store 14 and a request for a combination with another mobile store that sells different types of products to the server 10 via the communication interface 31 in response to input from the merchant B, who operates the mobile store 14. The controller 22 of the server 10 then receives the information of the types of products and the request for combination via the communication interface 20.

Based on the information of the product types of each store, the controller 22 of the server 10 determines a combination of the mobile stores 13, 14, capable of combining the product types requested by the consumer in step S506. Although a pair of mobile stores 13, 14 is illustrated for the sake of convenience in the present embodiment, the controller 22 may, for example, collect information on the types of products of three or more mobile stores from respective merchants and determine a combination of mobile stores, from among the three or more mobile stores, capable of combining the product types requested by the consumer. One merchant may operate a plurality of mobile stores, in which case the server 10 may receive information of the types of products of a plurality of mobile stores from one merchant.

In step S508, the controller 22 of the server 10 transmits a request to provide cruising range information to the mobile store 13 via the communication interface 20. The controller 45 of the mobile store 13 then receives an instruction, via the communication interface 40, to provide the cruising range. In step S510, as in step S508, the controller 22 of the server 10 transmits a request for the cruising range to the mobile store 14 via the communication interface 20. The controller 45 of the mobile store 14 then receives an instruction, via the communication interface 40, to provide the cruising range.

The cruising range request for each of the mobile stores 13, 14 from the server 10 in steps S508 and S510 may be relayed by the merchant terminal apparatuses 15, 16, respectively.

In step S512, the controller 45 of the mobile store 13 transmits the information on the cruising range of the mobile store 13 to the server 10 via the communication interface 40 together with the position information indicating the current position. The controller 45 acquires the information on the remaining amount of the energy source of the drive mechanism 46 from the detector 44. Based on the information acquired from the detector 44, the controller 45 then derives the information on the cruising range of the mobile store 13. The controller 45 also acquires position data indicating the current position from the positioner 41. The controller 45 then transmits the information on the cruising range and the position information to the server 10. The controller 22 of the server 10 then receives the information on the cruising range and the position information via the communication interface 20.

In step S514, as in step S512, the controller 45 of the mobile store 14 transmits the information on the cruising range of the mobile store 14 to the server 10 via the communication interface 40 together with the position information indicating the current position. The controller 22 of the server 10 then receives the information on the cruising range and the position information via the communication interface 20.

As a modification to steps S512 and S514, the mobile stores 13, 14 may transmit information on the cruising range and position information to the merchant terminal apparatuses 15, 16, respectively, and the merchant terminal apparatuses 15, 16 may each transmit information on the cruising range and position information to the server 10. Alternatively, the mobile stores 13, 14 may transmit information, such as the remaining amount of energy detected by the detector 44, to the server 10 for the server 10 to determine the cruising range of the mobile stores 13, 14. The mobile stores 13, 14 may instead transmit information, such as the remaining amount of energy, to the merchant terminal apparatuses 15, 16 respectively, and the merchant terminal apparatuses 15, 16 may then calculate the cruising range of the mobile stores 13, 14 respectively and transmit the cruising range to the server 10. Furthermore, the mobile stores 13, 14 may each transmit the position information apart from the information on the cruising range to the server 10 either via the merchant terminal apparatuses 15, 16 or directly.

In step S516, the controller 22 of the server 10 determines a common circulation route over which the mobile stores 13, 14 are to circulate as a group, such as a caravan. The common circulation route may be any route with a distance equal to or less than the shortest cruising range between the cruising ranges of the mobile stores 13, 14. For example, from among passing points arbitrarily determined in advance, the controller 22 selects the passing point closest to the current position of the mobile stores 13, 14 as a starting point. The controller 22 then selects the routes, from among routes passing through the remaining passing points, with a distance equal to or less than the shortest cruising range between the cruising ranges of the mobile stores 13, 14 and determines that the longest route among the selected routes is the common circulation route. The common circulation route may be a route that passes through or near the consumer's location. The controller 22 may, for example, determine the common circulation route based on the position information of the consumer's location received from the consumer terminal apparatus 11 by adding the consumer's location as a passing point or by requiring passage through the passing point nearest to the location.

In step S518, the controller 22 of the server 10 transmits the information on the common circulation route to the consumer terminal apparatus 11 via the communication interface 20. Information indicating the combination of products sold by the mobile stores 13, 14 may be attached to the information on the common circulation route. The controller 33 of the consumer terminal apparatus 11 then receives the information on the common circulation route via the communication interface 31.

In step S520, the controller 33 of the consumer terminal apparatus 11 outputs the information on the common circulation route via the input/output interface 30 to request that the consumer approve the common circulation route. For example, the controller 33 displays the common circulation route and the consumer's location on the display. Furthermore, a combination of products sold by mobile stores 13, 14 may be displayed. When the consumer subsequently approves the common circulation route by providing input to a touch panel integrated with the display, the controller 33 receives information indicating the approval. In this way, consumers can learn that mobile stores providing a combination of requested products is on the way, thereby increasing the convenience for consumers.

In step S522, the controller 33 of the consumer terminal apparatus 11 transmits information approving the common circulation route to the server 10 via the communication interface 31. The controller 22 of the server 10 receives information approving the common circulation route via the communication interface 20. Step S524 and subsequent steps may be performed on the condition that approval of the common circulation route is obtained from the consumer terminal apparatus 11. In this case, the controller 22 of the server 10 instructs the merchant terminal apparatuses 15, 16 and the mobile stores 13, 14 to stop the circuit sales, for example, when approval of the common circulation route is not obtained from the consumer terminal apparatus 11.

In step S524, the controller 22 of the server 10 transmits the information on the common circulation route to the merchant terminal apparatus 15 via the communication interface 20. The controller 33 of the merchant terminal apparatus 15 then receives the information on the common circulation route via the communication interface 31.

In step S526, as in step S524, the controller 22 of the server 10 transmits the information on the common circulation route to the merchant terminal apparatus 16 via the communication interface 20. The controller 33 of the merchant terminal apparatus 16 then receives the information on the common circulation route via the communication interface 31.

In step S528, the controller 33 of the merchant terminal apparatus 15 outputs the information on the common circulation route via the input/output interface 30 to request confirmation from the merchant A. Information on the formed combination of the mobile stores 13, 14 is included in the information on the common circulation route. The controller 33 displays the combination of mobile stores 13, 14 and the common circulation route, for example, on the display. This enables the merchant A to confirm that the mobile store 13 will circulate while selling products in combination with the mobile store 14 and to confirm the corresponding common circulation route. The merchant A can therefore predict, to a certain degree, the sales volume from the circuit sale of products by the mobile store 13. When the merchant A subsequently provides input to the touch panel, integrated with the display, to confirm the common circulation route, the controller 33 receives information indicating the confirmation.

In step S530, as in step S528, the controller 33 of the merchant terminal apparatus 16 outputs the information on the common circulation route via the input/output interface 30 to request confirmation from the merchant B. The merchant B can confirm that the mobile store 14 will circulate while selling products in combination with the mobile store 14 and confirm the corresponding common circulation route. This enables the merchant B to predict, to a certain degree, the sale of products during circulation by the mobile store 14. When the merchant B subsequently provides input to the touch panel, integrated with the display, to confirm the common circulation route, the controller 33 receives information indicating the confirmation.

In step S532, the controller 33 of the merchant terminal apparatus 15 transmits the information confirming the common circulation route to the server 10 via the communication interface 31. The controller 22 of the server 10 receives, via the communication interface 20, the information confirming the common circulation route.

In step S534, as in step S532, the controller 33 of the merchant terminal apparatus 16 transmits information confirming the common circulation route to the server 10 via the communication interface 31. The controller 22 of the server 10 receives, via the communication interface 20, the information confirming the common circulation route.

In step S536, the controller 22 of the server 10 transmits the information on the common circulation route and an instruction to start circulating to the mobile store 13 via the communication interface 20. The controller 45 of the mobile store 13 then receives, via the communication interface 40, the information on the common circulation route and the instruction to start circulating.

In step S538, as in step S536, the controller 22 of the server 10 transmits the information on the common circulation route and the instruction to start circulating to the mobile store 14 via the communication interface 31. The controller 45 of the mobile store 14 then receives, via the communication interface 40, the information on the common circulation route and the instruction to start circulating.

The information transmitted and received between the server 10 and the mobile stores 13, 14 in steps S536 and S538 may be relayed by the merchant terminal apparatuses 15, 16, respectively.

In step S540, the controller 45 of the mobile store 13 controls the mobile store 13 so that the mobile store 13 sells products while circulating along the common circulation route. For example, the controller 45 displays the common circulation route with the display of the input/output interface 43 to prompt a crew member of the mobile store 13 to start moving the mobile store 13 along the common circulation route. Alternatively, the controller 45 may instruct an automatic driving control apparatus of the mobile store 13 to start moving along the common circulation route. The mobile store 13 starts moving along the common circulation route, meets up with the mobile store 14 at a set meeting point, and circulates as a group with the mobile store 14.

In step S542, as in step S540, the controller 45 of the mobile store 14 controls the mobile store 14 to sell products while circulating along the common circulation route. The mobile store 14 starts moving along the common circulation route, meets up with the mobile store 13 at a set meeting point, and circulates as a group with the mobile store 13.

While circulating as a group along the circulation route, the mobile stores 13, 14 park together at arbitrary points and each sell products.

The procedure of FIG. 5 enables circuit sales as a group by a plurality of mobile stores with different cruising ranges. Consumers can thereby easily acquire a combination of different types of products. On the other hand, the merchant A or B can expect increased sales opportunities for their own products through collaboration with other merchants. When the server 10 determines the combination of mobile stores in step S506, the request from the consumer terminal apparatus 11 in step S500 is not necessarily a condition. For example, the merchant may take the initiative in requesting the sale of products by a combination of a plurality of mobile stores, and a combination of mobile stores of a plurality of merchants who made requests may be determined on the server 10.

FIG. 6 illustrates an operation procedure of the information processing system 1 when the mobile stores 13, 14 adjust incentives of the merchants A, B. From the perspective of the merchant with the shorter cruising range of the mobile store between the merchants A, B, circuit sales along the common circulation route nearly fully utilize the potential sales opportunities of the mobile store. Conversely, from the perspective of the merchant with the longer cruising range, circuit sales along the common circulation route might diminish the potential sales opportunities that could have been obtained by the mobile store circulating through a wider area. The merchants A, B may therefore have conflicting interests. The procedure of FIG. 6 is for adjusting these interests.

The procedure of FIG. 6 is executed at the time the common circulation route in FIG. 5 is determined. The procedure illustrated in FIG. 6 is, for example, executed between steps S516 and S518, or between steps S534 and S536.

In step S600, the controller 22 of the server 10 determines an incentive to be exchanged between the merchant A and the merchant B. An example in which the cruising range of the mobile store 13 is shorter than the cruising range of the mobile store 14 is described for the sake of convenience. The common circulation route is therefore determined so that the distance of the common circulation route is equal to or less than the cruising range of the mobile store 13. In this case, the controller 22 determines that an incentive is to be paid from the merchant A to the merchant B and determines the amount of the incentive. The incentive may be actual or virtual currency, points that have a shared economic value for merchants A and B, or the like.

The controller 22 of the server 10 determines the amount of the incentive based on the difference between the cruising range of the mobile store 14 and the length of the common circulation route. For example, based on the distance of the circulation route and the sales revenue of each mobile store in the past, the controller 22 calculates the expected sales revenue per unit travel distance for each mobile store and stores the calculated expected sales revenue in the memory 21. The controller 22 then calculates the amount of the incentive by multiplying the difference between the cruising range of the mobile store 14 and the length of the common circulation route by the expected sales revenue per unit travel distance of the mobile store 13. The controller 22 may instead multiply the difference between the cruising range and the length of the common circulation route by the expected sales revenue and then further multiply by any coefficient to adjust the amount of the incentive. The coefficient can be set in advance based on the difference in sales volume between the merchants. The interests of both merchants can be adjusted by having the merchant A pay the merchant B the incentive calculated in this way.

When an increase in sales is expected as a synergistic effect of the mobile stores 13, 14 selling products together, the controller 22 may adjust the incentive in accordance with the extent of the benefit obtained by the synergistic effect. For example, when the benefit from the mobile stores 13, 14 selling products as a group is greater for the merchant B than for the merchant A, the controller 22 weights the incentive to reduce the incentive paid by the merchant A to the merchant B. The controller 22 reduces the incentive paid by the merchant A to the merchant B by X% (where X is a positive real number) when, for example, the sales revenue increased by X% in the past as a result of the merchant B collaborating with the merchant A. Conversely, when the benefit from the mobile stores 13, 14 selling products as a group is greater for the merchant A than for the merchant B, the controller 22 weights the incentive to increase the incentive paid by the merchant A to the merchant B. The controller 22 increases the incentive paid by the merchant A to the merchant B by X% when, for example, the sales revenue increased by X% in the past as a result of the merchant A collaborating with the merchant B.

In step S602, the controller 22 of the server 10 transmits incentive information to the merchant terminal apparatus 15 via the communication interface 20. The incentive information includes the payer and recipient of the incentive and the amount of the incentive, for example. The controller 33 of the merchant terminal apparatus 15 then receives the incentive information via the communication interface 31.

In step S604, as in step S602, the controller 22 of the server 10 transmits the incentive information to the merchant terminal apparatus 16 via the communication interface 20. The controller 33 of the merchant terminal apparatus 16 then receives the incentive information via the communication interface 31.

In step S606, the controller 33 of the merchant terminal apparatus 15 outputs the incentive information via the input/output interface 30 to request confirmation from the merchant A. The controller 33 displays the payer and recipient of the incentive and the amount of the incentive, for example, on a display. This enables the merchant A to confirm the incentive to pay to the merchant B for the mobile store 13 circulating while selling products in combination with the mobile store 14. When the merchant A subsequently provides input to the touch panel, integrated with the display, to approve of the incentive, the controller 33 receives information indicating the approval.

In step S608, as in step S606, the controller 33 of the merchant terminal apparatus 16 outputs incentive adjustment information via the input/output interface 30 to prompt for approval. The controller 33 displays the payer and recipient of the incentive and the amount of the incentive, for example, on a display. This enables the merchant B to confirm the incentive to receive from the merchant A for the mobile store 14 circulating while selling products in combination with the mobile store 13. When the merchant B subsequently provides input to the touch panel, integrated with the display, to approve of the incentive, the controller 33 receives information indicating the approval.

In step S610, the controller 33 of the merchant terminal apparatus 15 transmits the information on confirmation of the incentive to the server 10 via the communication interface 31. The controller 22 of the server 10 then receives the information indicating confirmation of the incentive via the communication interface 20.

In step S612, the controller 33 of the merchant terminal apparatus 16 transmits the information on confirmation of the incentive to the server 10 via the communication interface 31. The controller 22 of the server 10 then receives the information indicating confirmation of the incentive via the communication interface 20.

In step S614, the controller 22 of the server 10 executes an incentive payment process for payment of the incentive from the merchant A to the merchant B. The controller 22 may, for example, execute a process to collaborate with the server of a financial institution or the like that manages accounts of the merchants A and B and to move assets corresponding to the incentive from the merchant A to the merchant B.

An example of the incentive being paid from the merchant A to the merchant B has been described. The above-described procedure may also be applied when the incentive is paid from the merchant B to the merchant A.

An example of determining the common circulation route and adjusting the interests between merchants for two mobile stores has been described, but the number of mobile stores and of merchants may be three or greater. In this case, the procedure for sending and receiving information between the server 10 and each merchant terminal apparatus and the procedure for sending and receiving information between the server 10 and each mobile store, illustrated in FIGS. 5 and 6, are additionally executed in accordance with the number of merchant terminal apparatuses and mobile stores.

When the number of mobile stores and merchants is three or greater, the common circulation route is determined so that the distance thereof is equal to or greater than the shortest cruising range among the cruising ranges of the three or more mobile stores. The interests with respect to other merchants are adjusted in this case by having the merchant who operates the mobile store with the shortest cruising range pay an incentive to the other merchants in accordance with the difference between each cruising range and the common circulation route. The incentive may also be calculated by multiplying by a coefficient freely set based on the difference in sales volume between the merchants.

The above-described method of calculating the incentive is only a non-limiting example. Any example that achieves similar effects is included in the scope of the present disclosure.

As described above, the present embodiment can optimize the circuit of a plurality of mobile stores while providing a combination of different types of products more suited to the needs of the consumer. Conflicting interests between merchants resulting from the determination of the common circulation route for the mobile stores can also be avoided.

In the above embodiment, a processing/control program that specifies operations of the controller 33 of the consumer terminal apparatus 11 and the merchant terminal apparatuses 15, 16 may be stored in the memory 21 of the server 10 or in the memory of another server and be downloaded onto each terminal apparatus via the network 12. The processing/control program may also be stored on a non-transitory portable recording/storage medium readable by each terminal apparatus, and each terminal apparatus may read the program from the medium. A processing/control program that specifies operations of the controller 45 of the mobile store 13 may be stored in the memory 21 of the server 10 or in the memory of another server and be downloaded onto the mobile store 13 via the network 12. The processing/control program may also be stored on a non-transitory portable recording/storage medium readable by the controller 45, and the controller 45 may read the program from the medium.

Although embodiments have been described on the basis of drawings and examples, it is to be noted that various changes and modifications may be implemented by those skilled in the art based on the present disclosure. Therefore, such changes and modifications are to be understood as included within the scope of the present disclosure. For example, the functions and the like included in the various means and steps may be reordered in any logically consistent way. Furthermore, means and steps may be combined into one or divided.

1. A server comprising:
a communication interface; and
a controller configured to transmit and receive information to and from other apparatuses via the communication interface;
wherein the controller is configured to receive information on a cruising range from each mobile store among a plurality of mobile stores selling different types of products and to transmit an instruction to the plurality of mobile stores to circulate as a group along a circulation route travelable by a first mobile store having a shortest cruising range.

2. The server of claim 1, wherein the controller is configured to receive position information from a terminal apparatus and to determine the circulation route so that the circulation route passes through a position corresponding to the position information.

3. The server of claim 2, wherein the controller is configured to notify the terminal apparatus of the circulation route and to transmit the instruction to the plurality of mobile stores on a condition that approval is obtained from the terminal apparatus.

4. The server of claim 1, wherein the controller is configured to perform a process of providing an incentive to an operator who operates a second mobile store, among the plurality of mobile stores, having a longer cruising range than the first mobile store.

5. The server of claim 4, wherein the controller is configured to perform a process in which the incentive is paid by an operator who operates the first mobile store.

6. The server of claim 5, wherein the controller is configured to determine the incentive in accordance with a difference between the cruising range of the second mobile store and a length of the circulation route.

7. An information processing system comprising the server and the mobile store of claim 1.

8. A control apparatus to be mounted in a mobile store and configured to transmit and receive information to and from a server and to control the mobile store,
wherein the control apparatus is configured to transmit information on a cruising range of the mobile store to the server;
wherein based on the information on the cruising range of the mobile store and information, transmitted from another mobile store configured to sell a different type of products from products sold by the mobile store, on the cruising range of the another mobile store, an instruction to circulate as a group along a circulation route travelable by the mobile store having a shortest cruising range is transmitted from the server to the mobile store and the another mobile store; and
wherein the control apparatus is configured to receive the instruction and control the mobile store to circulate along the circulation route.

9. A non-transitory medium readable by a control apparatus of a mobile store and storing a program which, when executed by the control apparatus, causes the control apparatus to execute operations of claim 8.

10. A mobile store comprising the control apparatus of claim 8.

11. A terminal apparatus capable of communicating with a server, capable of input and output of information, and configured to execute operations of claim 2.

12. A non-transitory medium readable by a controller of a terminal apparatus capable of communicating with a server and of input and output of information, the medium storing a program which, when executed by the controller, causes the terminal apparatus to execute operations of claim 2.

13. An operation method of an information processing system comprising a server and a plurality of mobile stores configured to communicate with the server, the operation method comprising:
selling, by each mobile store, different types of products and transmitting, by each mobile store, a cruising range of the mobile store to the server; and
transmitting, by the server, an instruction to each mobile store to circulate as a group along a circulation route travelable by a first mobile store having a shortest cruising range.

14. The operation method of claim 13, further comprising receiving, by the server, position information from a terminal apparatus and determining the circulation route so that the circulation route passes through a position corresponding to the position information.

15. The operation method of claim 14, further comprising notifying, by the server, the terminal apparatus of the circulation route and causing the terminal apparatus to output the circulation route.

16. The operation method of claim 15, further comprising transmitting, by the server, the instruction to each mobile store on a condition that the server receives information, from the terminal apparatus, indicating approval of the circulation route outputted by the terminal apparatus, the terminal apparatus being configured to receive input of the approval of the circulation route.

17. The operation method of claim 13, further comprising performing, by the server, a process of providing an incentive to an operator who operates a second mobile store, among the plurality of mobile stores, having a longer cruising range than the first mobile store.

18. The operation method of claim 17, further comprising performing, by the server, a process in which the incentive is paid by an operator who operates the first mobile store.

19. The operation method of claim 18, further comprising determining, by the server, the incentive in accordance with a difference between the cruising range of the second mobile store and a length of the circulation route.

20. The operation method of claim 13, further comprising circulating, by the plurality of mobile stores, as a group along the circulation route in response to the instruction.
